(19) United States
(12) Patent Application Publication
(10) Pub. No.: US 2005/0055159 A1
(43) Pub. Date: Mar. 10, 2005

(54) Method for off-line routing

(75) Inventors: Ju-Yeon Song, Seoul (KR); Joon-Goo Park, Seoul (KR); Wuk Kim, Namyangju-si (KR); Jae-Woon Park, Yongin-si (KR); Han-Na Lim, Siheung-si (KR); Eun-Taek Lim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/890,705

(22) Filed: Jul. 14, 2004

(30) Foreign Application Priority Data
Sep. 9, 2003 (KR) 63425/2003

(51) Int. Cl. G01C 21/34

(52) U.S. Cl. 701/209; 340/995.19

(57) ABSTRACT

Disclosed is a method for off-line routing by using a navigation terminal. The method includes the steps of creating second route guidance information in response to a route guidance request from a first location to a second location by utilizing first route guidance information, which had been stored in a navigation terminal for determining a route from the second location to the first location and outputting the second route guidance information as audio data, video data, or a combination thereof. Thus, a driver is not required to pay charges for route guidance information when the driver returns to the first location from the second location.

### PRIORITY

This application claims priority to an application entitled “Method for Off-Line Routing” filed in the Korean Industrial Property Office on Sep. 9, 2003 and assigned Serial No. 2003-63425, the contents of which are incorporated herein by reference.

### BACKGROUND OF THE INVENTION

1. Field of the Invention

The present invention relates to a method for guiding a route for a moving object along a route, and more particularly to a method for calculating a reverse-route for a moving object by utilizing route guiding information, which is preset in a navigation terminal, without connecting the navigation terminal to a server of an information center.

2. Description of the Related Art

Recently, various kinds of navigation terminals equipped with inexpensive intelligent transport information systems having a GPS (global positioning system) receiver have been developed. Such a navigation terminal typically does not include map data or a route calculating module capable of calculating a route, in order to realize the terminal as an inexpensive intelligent transport information system. Therefore, the navigation terminal must be connected to an information center through a communication network in order to receive peripheral information and an optimal route reflecting a present traffic situation, as well as to request an emergency service based on a present position of the navigation terminal obtained through a GPS module. At this time, a user may input a destination or services through voice or characters by using the navigation terminal. In addition, the navigation terminal may receive route guidance data in the form of voice, characters or image data in response to the request of the user. The information center has an updated map database capable of calculating the route so that the information center can calculate the route reflecting the present traffic situation based on the present position and destination of the user, which are transmitted to the information center through a communication network.

Such an intelligent transport information system using the navigation terminal is especially useful for drivers traveling on a new road or an unfamiliar route. That is, a driver traveling on the new road or unfamiliar route may receive route guidance information from the information center based on the present location of the driver, so that the driver can correctly arrive at the destination.

FIG. 1 is a view showing a conventional route guiding procedure. Referring to FIG. 1, a navigation terminal 10 may access to an information center 30 through a common carrier 20 providing a mobile communication service to the navigation terminal 10 in order to request route guidance information from a present location to a destination (S12 and S14). Then, the information center 30 creates route guidance information and transmits route guidance information to the navigation terminal 10 through the common carrier 20 in response to the route guidance request (S16 and S18). At this time, the user having the navigation terminal 10 must pay a charge for route guidance information transmitted from the information center 30 and a usage fee for the network.

In addition, if the user wants to receive route guidance information when the user attempts to return to the start position from the destination, the user must access to the information center 30 again by using the navigation terminal 10. That is, the user must carry out the procedure as shown in FIG. 1 in order to receive reverse-route guidance information from the information center. Thus, the user must pay a charge for receiving reverse-route guidance information even though the user has previously paid a charge when receiving the initial route guidance information.

Reverse-route guidance information is simply the reverse of route guidance information, which has already been transmitted to the navigation terminal 10 of the user. Therefore, it is very uneconomical for the user if the user must pay the charge for the reverse-route guidance information at the same rate as the charge required for receiving the route guidance information.

### SUMMARY OF THE INVENTION

Accordingly, the present invention has been made to solve the above- mentioned problems occurring in the prior art, and a first object of the present invention is to provide a method for off-line routing while reducing an economic burden by creating off-line route guidance information without connecting a navigation terminal to an information center.

A second object of the present invention is to provide a method for off-line routing capable of creating reverse-route guidance information by utilizing route guidance information, which has been transmitted into a navigation terminal and stored therein.

A third object of the present invention is to provide a method for off-line routing capable of providing route guidance information from a start position to a destination or vice versa even though a user accesses an information center only one time.

To accomplish the above objects, according to one aspect of the present invention, there is provided a method of determining a route for a driver by downloading route guidance information through a communication network, the method comprising the steps of: creating second route guidance information in response to a route guidance request from a first location to a second location by utilizing first route guidance information, which had been stored in a navigation terminal for determining a route from the second location to the first location; and outputting second route guidance information as one of audio data, video data, or a combination thereof.

To accomplish the above objects, according to another aspect of the present invention, there is provided a method of determining a route for a driver by downloading route guidance information through a communication network, the method comprising the steps of: storing route guidance information in a navigation terminal by receiving route guidance information through the communication network in response to a route guidance request from a first location to a second location; outputting route guidance information stored in the navigation terminal as one of audio data, video data, or a combination thereof; determining a start position and a destination in response to a reverse-route guidance request from the second location to the first location; creating reverse-route guidance information from the start position to the destination by utilizing route guidance information stored in the navigation terminal; and outputting reverse-route guidance information stored in the navigation terminal as one of audio data, video data, or a combination thereof.

### BRIEF DESCRIPTION OF THE DRAWINGS

The above objects and other features and advantages of the present invention will be more apparent from the following detailed description taken in conjunction with the accompanying drawings, in which:

FIG. 1 is a view of a conventional route guidance procedure;

FIG. 2 is a flow chart of a route guidance procedure according to one embodiment of the present invention;

FIG. 3 is a flow chart of an off-line reverse-route guidance procedure according to one embodiment of the present invention; and

FIGS. 4 and 5 are example views for explaining an off-line reverse-route guidance procedure according to one embodiment of the present invention.

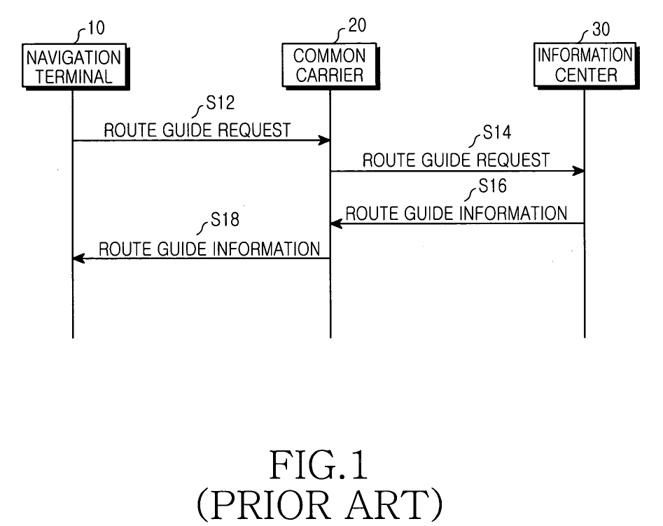

### DETAILED DESCRIPTION OF THE PREFERRED EMBODIMENT

Hereinafter, a preferred embodiment of the present invention will be described with reference to the accompanying drawings. In the following description of the present invention, the same reference numerals are used to designate the same or similar components, and a detailed description of known functions and configurations incorporated herein will be omitted when it may obscure the subject matter of the present invention.

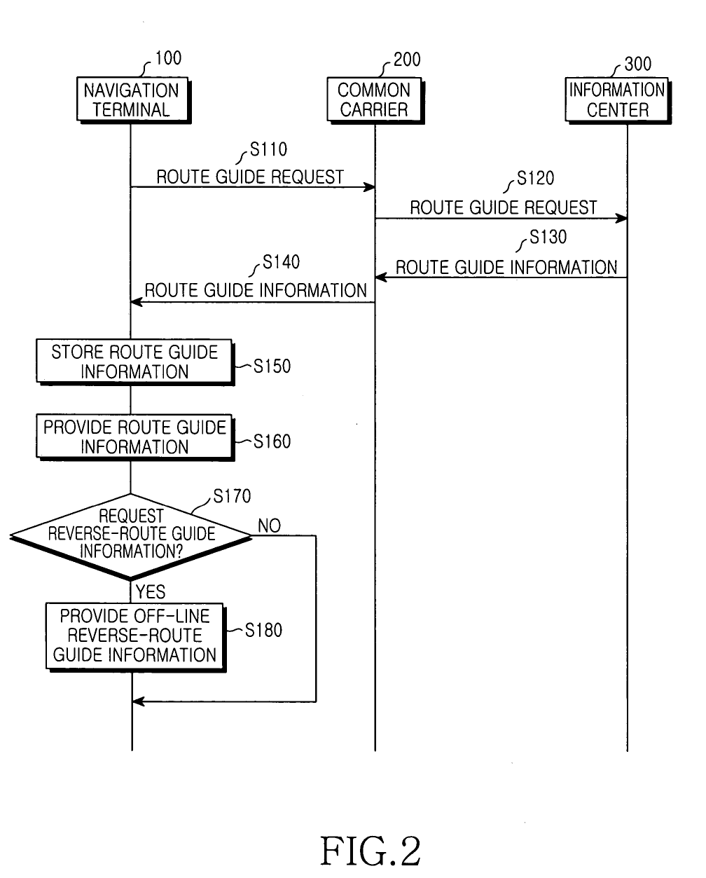

Referring to FIG. 2, the route guidance procedure according to one embodiment of the present invention includes the steps of providing initial route guidance information to a driver by receiving initial route guidance information from an information center (S110 to S160) and providing reverse-route guidance information to the driver by creating reverse-route guidance information based on the initial route guidance information (S170 and S180).

At this time, the steps of providing initial route guidance information to the driver by receiving initial route guidance information from the information center (S110 to S160) are similar to those of a conventional procedure. That is, a navigation terminal 100 accesses the information center 300 through a common carrier 200 providing a mobile communication service to the navigation terminal 100 in order to request a route guidance service (S110 and S120). Then, the information center 300 creates route guidance information in response to the route guidance request and sends route guidance information to the navigation terminal 100 through the common carrier 200 (S130 and S140).

Upon receiving route guidance information, the navigation terminal 100 stores route guidance information therein (S150). At this time, the navigation terminal 100 stores route guidance information in a memory thereof: The route guidance information includes header information, node point information, and interpolation point information. Node point information consists of names of intersections, links and roads, angles between an intersection and adjacent roads, and X and Y coordinates on a map. The names of the intersections are text data, such as “Samsung crossroads”. The kinds of roads signify a class of roads, such as national roads and provincial roads. The kinds of links signify a class of links, such as a U-turn, a rotary, an over pass, an under pass and a bridge.

The angles between the intersection and adjacent roads include an intersection-in angle, an intersection-out angle, an angle of a right road of an exit road on the basis of a north direction, and an angle of a left road of the exit road on the basis of a north direction. Such route guidance information stored in the navigation terminal 100 includes information regarding links and nodes corresponding to an optimal route from a first point to a second point. In addition, the navigation terminal 100 preferably stores node identification codes, coordinates of nodes, a direction vector from one node to a next node, and traveling information corresponding to nodes, with respect to each node included in the route guidance information. The direction vector from one node to the next node represents a direction based on a moving direction of the navigation terminal 100. The direction vector is necessary when creating reverse-route guidance information so it must be included in the route guidance information. In addition, traveling information of the nodes may include road information, such as “one-way” and “road under construction”, and regional information, such as “Apgujung crossroads”, “front of court” and “Kyodae crossroads” in order to provide information when creating reverse-route guidance information. When providing reverse-route guidance information, stored information of a present node cannot be used as information of the present node, but can be used as information of a next node so that the user can receive traveling information corresponding to the next node in advance.

After route guidance information has been stored, the navigation terminal 100 outputs the route guidance information so as to provide the route guidance information to the driver or user (S160). At this time, route guidance information is transmitted to the driver as audio data, such as voice signals, video data, characters or arrows or a combination thereof. It is very dangerous for the driver to check a display section of the navigation terminal 100 by averting his eyes to the display section while driving a vehicle. Thus, it is preferred to provide route guidance information, such as “turn left after running loom”, with a voice signal. In addition, it is preferred to selectively output route guidance information corresponding to present position information of the navigation terminal 100 after detecting the present position information of the navigation terminal 100.

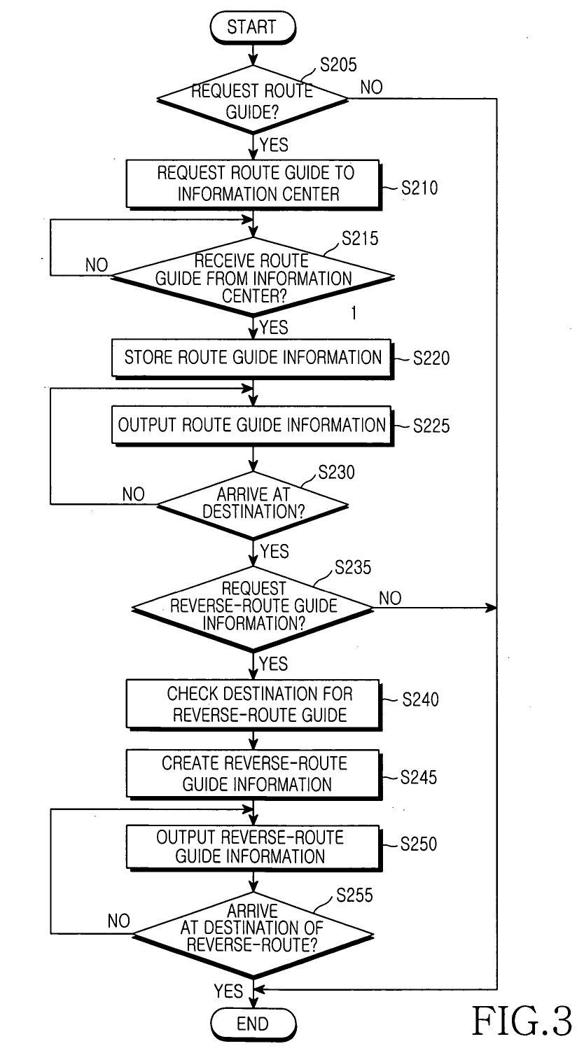

When the driver requests reverse-route guidance information through the navigation terminal 100 which had provided the driver with route guidance information transmitted from the information center 300 through the communication network (S170), the navigation terminal 100 provides off-line route guidance information by using the route guidance information, which is stored in step S150. That is, the navigation terminal 100 creates reverse-route guidance information and sends it to the driver (S180). Such a procedure for providing reverse-route guidance information to the driver is shown in FIG. 3, in detail.

FIG. 3 is a flow chart showing an off-line reverse-route guidance procedure according to one embodiment of the present invention. Referring to FIG. 3, when a route guidance service for a predetermined destination is requested by the driver (S205), the navigation terminal 100 requests a route guidance to the information center through the communication network (S210). At this time, a start point for the route guidance is determined as a present position of the navigation terminal 100, which is detected by using a GPS module accommodated in the navigation terminal 100, and the destination may be inputted into the navigation terminal 100 by the driver.

When route guidance information is transmitted to the navigation terminal 100 from the information center 300 in response to the request of the driver (S215), the navigation terminal 100 stores the route guidance information therein (S220). At this time, the navigation terminal 100 manages the route guidance information based on nodes included in the route guidance information. For instance, the navigation terminal 100 stores node identification codes, coordinates of nodes, a direction vector from one node to a next node, and traveling information corresponding to the nodes. The direction vector from one node to the next node represents a direction based on a moving direction of the navigation terminal 100 and is necessary when creating reverse-route guidance information so it must be included in the route guidance information. In addition, traveling information corresponding to the node may include turn restriction information, such as “left turn only” and “no left turn”, road information, such as “one-way” and “road under construction”, and regional information, such as “Apgujung crossroads”, “front of court” and “Kyodae crossroads”. Preferably, the route guidance information is stored in a memory provided in the navigation terminal 100.

The navigation terminal having route guidance information stored therein outputs the route guidance information based on the present position information of the navigation terminal until the driver arrives at the destination (S225 and S230). At this time, step S225 of outputting route guidance information includes substeps of detecting the present position information of the navigation terminal 100 by using the GPS module accommodated in the navigation terminal 100, and selectively outputting route guidance information corresponding to the present position information of the navigation-terminal from the route guidance information, which has been received in the navigation terminal 100 in step S215.

In step S225, the route guidance information is preferably outputted as one of audio data (for example, voice signals), video data (for example, characters and arrows), or a combination thereof.

While the route guidance procedure is being carried out based on route guidance information transmitted to the navigation terminal 100 from the information center 300 through the communication network, if the user of the navigation terminal 100 arrives at the destination (S230), it is determined if the driver requests a reverse-route guidance information (S235). If the driver requests the reverse-route guidance information, the navigation terminal 100 checks the start position and destination for the reverse-route guidance information (S240). At this time, the start position is preferably determined as the present position of the navigation terminal.

In addition, the navigation terminal 100 creates reverse-route guidance information in response to the request for the reverse-route guidance information by using the route guidance information stored in step S220. That is, the navigation terminal 100 creates a direction vector of the reverse-route guidance information by converting the direction vector of the route guidance information, which was previously saved in the memory of the navigation terminal, thereby creating the reverse-route guidance information including the direction vector.

For example, if the direction vector of the stored route guidance information with respect to a predetermined position C satisfies Equation 1 as shown below, the direction vector of the reverse-route guidance information may be created as shown in Equation 2.

$$\begin{matrix}\vec{C} = {C}_{x} \vec{x} + {C}_{y} \vec{y} ; {C}_{x}^{2} + {C}_{y}^{2} = 1 & & Equation 1 \\ \vec{C} = - {C}_{x} \vec{x} + {C}_{y} \vec{y} ; {C}_{x}^{2} + {C}_{y}^{2} = 1 & & Equation 2\end{matrix}$$

That is, if the direction vector is stored as two-dimensional information, it is enough to convert only an x-axis direction vector. This is because the direction vector is not an absolute direction obtained by utilizing coordinates transmitted from the GPS, but a relative direction according to a moving direction of the user.

Created reverse-route guidance information is then outputted (S250). At this time, in the same manner with step S225, reverse-route guidance information is preferably outputted as one of audio data (for example, voice signals), video data (for example, characters and arrows), or a combination thereof.

In addition, step 250 includes substeps of detecting the present position information of the navigation terminal 100 by using the GPS module supplied in the navigation terminal 100, and selectively outputting reverse-route guidance information corresponding to the present position information of the navigation terminal from the reverse-route guidance information, which has been received in the navigation terminal 100 in step S245.

In addition, turn restriction information and road information included in the route guidance information can be used when the user drives a vehicle by using the reverse-route guidance information. In step 250, properties of a next link can be obtained by using stored traveling information of the node. That is, traveling information corresponding to the node stored in step 150 is used as information of a next node when the user drives the vehicle according to the reverse-route guidance information. For example, if the next link is “one-way”, the route guidance information and a notice message for the “one-way” are simultaneously outputted. In other words, reverse-route guidance information is created by simply converting the x-axis direction vector of the stored route guidance information, thereby preventing the driver from traveling along a wrong direction of the one-way road. In a case of turn restriction information, it is required to provide left turn information at a predetermined area when a reverse-route guidance procedure is carried out if right turn information has been provided at the predetermined area when the initial route guidance procedure is carried out. However, if the predetermined area is a “no left turn” area, the driver cannot pass through the predetermined area. For this reason, it is required to add “no left turn” information to the route guidance information when creating the initial route guidance information in such a manner that the driver makes a detour at the predetermined area.

Step 250 is repeatedly carried out until the driver arrives at the destination on the reverse-route.

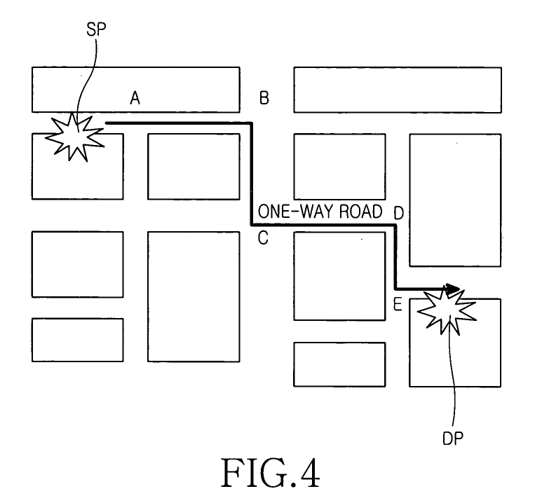

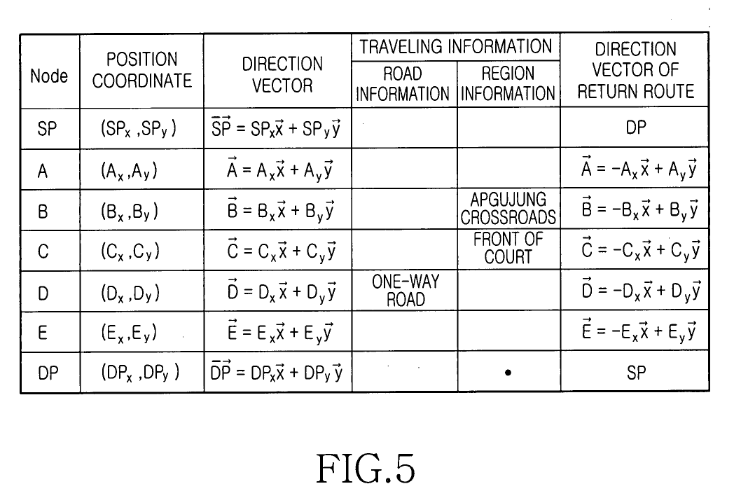

FIGS. 4 and 5 are example views for explaining the off-line reverse-route guidance procedure according to one embodiment of the present invention.

FIG. 4 shows a plurality of nodes A, B, C, D and E positioned between a start position SP and a destination DP, and FIG. 5 shows an example of route guidance information for allowing a driver to make a round trip from the start position SP to the destination DP. Particularly, FIG. 5 shows position coordinates, direction vectors, region information, return-route direction vectors corresponding to nodes positioned between the start position SP and the destination DP. That is, when the driver moves to the destination DP from the start position SP according to the route guidance information, the driver may sequentially pass through the nodes in an order of “SP-A-B-C-D-E-DP”. In addition, when the driver returns to the start position from the destination DP according to the reverse guidance information, the driver may sequentially pass through the nodes in an order of “DP-E-D-C-B-A-SP”, wherein position coordinates and direction vectors of the nodes are shown in FIG. 5. When the user driving a vehicle according to the reverse-route guidance information passes through the node D, the driver may receive traveling information corresponding to a next node. That is, the navigation terminal outputs traveling information corresponding to the next node to the driver, so the driver can carefully drive the car. At this time, if it is impossible to enter into the next node because the next node is a “one-way” road or a “no left turn” area, the driver makes a detour by using map information displayed in a display section of the navigation terminal.

As described above, the present invention can provide a driver with reverse-route guidance information regarding a predetermined route at an inexpensive cost by utilizing the initial route guidance information, which is stored in a navigation terminal.

While the present invention has been shown and described with reference to certain preferred embodiments thereof, it will be understood by those skilled in the art that various changes in form and details may be made therein without departing from the spirit and scope of the invention as defined by the appended claims.

1. A method of determining a route for a driver by downloading route guidance information through a communication network, the method comprising the steps of:
i) creating second route guidance information in response to a route guidance request from a first location to a second location by utilizing first route guidance information, which has been stored in a navigation terminal, for determining a route from the second location to the first location; and
ii) outputting second route guidance information as at least one of audio data and video data.

2. The method as claimed in claim 1 wherein, in step i) the first location is a present position of the navigation terminal detected by using a GPS module accommodated in the navigation terminal, and the second location is a destination input by the driver.

3. The method as claimed in claim 1, wherein in step i) a direction vector of the second route guidance information is created in response to the route guidance request from the first location to the second location by converting a direction vector of the first route guidance information, which is stored in the navigation terminal.

4. The method as claimed in claim 2, wherein in step i) a direction vector of the second route guidance information is created in response to the route guidance request from the first location to the second location by converting a direction vector of the first route guidance information, which is stored in the navigation terminal.

5. The method as claimed in claim 1, wherein step i) includes the substeps of creating turn restriction information and traveling information in response to the route guidance request based on the first route guidance information previously stored in the navigation terminal, and creating the second route guidance information by utilizing the turn restriction information and traveling information.

6. The method as claimed in claim 1, wherein step ii) includes the substeps of detecting present position information of the navigation terminal, and selectively outputting route guidance information from the second route guidance information corresponding to present position information of the navigation terminal.

7. The method as claimed in claim 6, wherein step ii) includes the substeps of obtaining at least one property of a next link based on route guidance information outputted corresponding to the present position of the navigation terminal, and outputting a notice message together with the route guidance information if the next link is a one-way road.

8. The method as claimed in claim 6, wherein step ii) includes the substeps of obtaining at least one property of a next link based on route guidance information outputted corresponding to the present position of the navigation terminal, and outputting a notice message together with the route guidance information if the next link includes a turn restriction area.

9. A method of determining a route for a driver by downloading route guidance information through a communication network, the method comprising the steps of:
i) storing route guidance information in a navigation terminal by receiving route guidance information through the communication network in response to a route guidance request from a first location to a second location;
ii) outputting route guidance information stored in the navigation terminal as at least one of audio data and video data;
iii) checking a start position and a destination in response to a reverse- route guidance request from the second location to the first location;
iv) creating reverse-route guidance information from the start position to the destination by utilizing the route guidance information stored in the navigation terminal; and
v) outputting the reverse-route guidance information stored in the navigation terminal as at least one of audio data and video data.

10. The method as claimed in claim 9, wherein in step i) the first location is a present position of the navigation terminal detected by using a GPS module accommodated in the navigation terminal, and the second location is the destination input by the driver.

11. The method as claimed in claim 9, wherein in step i) node identification codes, coordinates of nodes, a direction vector from one node to a next node, and traveling information corresponding to nodes are stored in the navigation terminal, with respect to each node included in the route guidance information.

12. The method as claimed in claim 11, wherein the direction vector represents a relative direction based on a moving direction of the navigation terminal.

13. The method as claimed in claim 9, wherein step ii) includes the substeps of detecting present position information of the navigation terminal, and selectively outputting route guidance information from route guidance information corresponding to present position information of the navigation terminal.

14. The method as claimed in claim 9, wherein step i) includes the substeps of creating turn restriction information and traveling information in relation to a reverse-route and storing the turn restriction information and traveling information in the navigation terminal together with the route guidance information, which is transmitted to the navigation terminal through the communication network.

15. The method as claimed in claim 9, wherein in step iii) the start position is a present position of the navigation terminal detected by using a GPS module accommodated in the navigation terminal.

16. The method as claimed in claim 9, wherein step iv) includes the substeps of creating a direction vector of the reverse-route guidance information by converting a direction vector of the route guidance information, which had been stored in the navigation terminal, and creating the reverse-route guidance information including the direction vector.

17. The method as claimed in claim 9, wherein step v) includes the substeps of detecting present position information of the navigation terminal, and selectively outputting the reverse-route guidance information from reverse-route guidance information corresponding to present position information of the navigation terminal.

18. The method as claimed in claim 17, wherein step v) includes the substeps of obtaining at least one property of a next link based on reverse-route guidance information corresponding to present position information of the navigation terminal, and outputting a notice message together with the reverse- route guidance information if the next link is a one-way road.

19. The method as claimed in claim 17, wherein step v) includes the substeps of obtaining at least one property of a next link based on reverse-route guidance information corresponding to present position information of the navigation terminal, and outputting a notice message together with the route guidance information if the next link includes a turn restriction area.
